(19) United States
(12) Patent Application Publication
(10) Pub. No.: US 2025/0067341 A1
(43) Pub. Date: Feb. 27, 2025

(54) GASKET MOUNTING STRUCTURE

(71) Applicant: NOK CORPORATION, Tokyo (JP)

(72) Inventor: Naoki HAGIWARA, Makinohara-shi, Shizuoka (JP)

(21) Appl. No.: 18/699,856

(22) PCT Filed: Nov. 10, 2022
(86) PCT No.: PCT/JP2022/041861

§ 371 Date: Sep. 25, 2024

(30) Foreign Application Priority Data
Dec. 6, 2021 (JP) 2021-197621

(51) Int. Cl. F16J 15/08

(52) U.S. Cl. CPC F16J 15/0818

(57) ABSTRACT

A plate shaped gasket mounting member having an endless gasket endlessly formed integrally therewith has through holes in a gasket mounting area. The gasket includes an endless first base disposed on an opposing surface, that extends along the mounting area, and that has a width which is wider than a hole size of each through hole, an endless second base disposed on a non-opposing surface, that extends along the mounting area, and that has a width wider than the hole size of each through hole and narrower than the first base, a third base disposed within each through hole and connects the first base and the second base, and a lip that protrudes, so that a distal end thereof is not included in an extension region of each through hole, from the first base in a direction away from each of the opposing surface and the extension region.

### CROSS REFERENCE TO RELATED APPLICATIONS

This application is a U.S. National Phase Application under 35 U.S.C. 371 of International Application No. PCT/JP2022/041861, filed on Nov. 10, 2022, which claims priority to Japanese Patent Application No. 2021-197621, filed on Dec. 6, 2021. The entire disclosures of the above applications are expressly incorporated by reference herein.

### BACKGROUND

### Technical Field

The present invention relates to a gasket mounting structure for mounting, to a gasket mounting member having a plate shape, a gasket endlessly formed by an elastic material that seals a gap between the gasket mounting member and an opposing member opposing the gasket mounting member.

### Related Art

Sealing mechanisms for sealing a gap between two members opposing each other by a gasket endlessly formed by an elastic material have been known. Such sealing mechanisms are used to seal (i.e., isolate from the outside) an inner space surrounded by the gasket.

Among these sealing mechanisms, there is a sealing mechanism in which the gasket is formed integrally with the one member (hereinafter, referred to as a gasket mounting member) of the two members that has a plate shape (see, for example, JP 2011-192584A). By using the mounting structure (gasket mounting structure) in which the gasket is integrally formed with the gasket mounting member in this manner, the number of parts is reduced and handling property is also improved as compared with a case in which a gasket is fixed on a gasket mounting member with some fixing members. Further, there is also an advantage that it is possible to avoid labor for processing the gasket mounting member to provide the gasket mounting member with a complicated shape such as a groove for holding the gasket.

When the gasket is integrally formed with the gasket mounting member, the gasket needs to be firmly fixed on the gasket mounting member in order to realize high sealability, and therefore, an adhesion process using an adhesive or the like is generally performed. However, the presence of the adhesion process tends to lead to increase of manufacturing cost. Therefore, further contrivance is required in order to reduce manufacturing cost of the gasket mounting structure in which the gasket is integrally formed while maintaining sealability thereof,

In view of the above-described circumstances, the present invention aims to realize both maintenance of sealability and reduction of manufacturing cost with good balance in the gasket mounting structure in which the gasket is integrally formed.

### SUMMARY

In order to solve the above problem, the present invention provides the following gasket mounting structure.

[1] A gasket mounting structure for mounting, to a gasket mounting member having a plate shape, a gasket endlessly formed by an elastic material that seals a gap between the gasket mounting member and an opposing member opposing the gasket mounting member, wherein
the gasket mounting member is provided with one or more through holes penetrating the gasket mounting member, in a mounting area thereof which has an endless shape corresponding to a shape of the gasket and on which the gasket is mounted, and
the gasket is formed integrally with the gasket mounting member in a non-adhesive manner, on both surfaces of the gasket mounting member along the mounting area and within the one or more through holes, and includes:
a first base portion having an endless shape, that is disposed on an opposing surface opposing the opposing member, of the both surfaces of the gasket mounting member, that extends along the mounting area having the endless shape, and that has a width along the opposing surface which is wider than a hole size of each of the one or more through holes,
a second base portion having an endless shape, that is disposed on a non-opposing surface on the opposite side of the opposing surface, of the both surfaces of the gasket mounting member, that extends along the mounting area having the endless shape, and that has a width along the non-opposing surface which is wider than the hole size of each of the one or more through holes and narrower than the width of the first base portion,
a third base portion that is disposed within each of the one or more through holes and connects the first base portion and the second base portion, and
a lip portion that is connected to the first base portion on the opposite side of the third base portion and protrudes, in such a manner that a distal end of the lip portion is not included in an extension region of each of the one or more through holes extending in a penetrating direction thereof, from the first base portion in a direction away from each of the opposing surface and the extension region.

[2] The gasket mounting structure according to [1], wherein the lip portion protrudes in an oblique direction to the extension region of each of the one or more through holes which is the direction away from the extension region, in a plane including a center line of the each of the one or more through holes and being perpendicular to a direction in which the mounting area extends.

[3] The gasket mounting structure according to [2], wherein the gasket includes a plurality of the lip portions which are disposed on opposite sides with the center line therebetween and protrude in the oblique directions which are different from each other.

[4] The gasket mounting structure according to [3], wherein the plurality of the lip portions extend at positions symmetrical to the center line in the oblique directions symmetrical to the center line.

### Effect of the Invention

In the gasket mounting structure according to the present invention, the gasket is formed integrally with the gasket mounting member in a non-adhesive manner, on both surfaces of the gasket mounting member along the mounting area and within the one or more through hole. Therefore, an adhesion process for adhering the gasket to the gasket mounting member with an adhesive or the like is unnecessary in the present invention, and the adhesion process is omitted, whereby the manufacturing cost thereof is reduced.

In addition, in the present invention, the first base portion and the second base portion that have the widths which are wider than the hole size of each of the through holes and that are connected by the third base portion are present on the both surfaces of the gasket mounting member, whereby the gasket 1 is firmly fixed on the gasket mounting member 2 even though it is in a non-adhesive manner.

In addition, generally, in a type of gasket which enters into a through hole, there is a difference in compressibility of the gasket between a portion thereof immediately below the through hole and another portion thereof around the through hole (the reason will be described later), so there is a concern that the difference in compressibility may affect the sealability of the gasket. In the gasket mounting structure according to the present, however, the lip portion protrudes, in such a manner that a distal end of the lip portion is not included in the extension region of the through hole, from the first base portion on the opposing surface of the gasket mounting member, whereby a sealing surface of the lip portion contacting the opposing member is apart from immediately below the through hole. Therefore, even if there is a difference in compressibility of the gasket between a portion thereof immediately below the through hole and another portion thereof around the through hole, the difference is prevented from affecting sealability of the gasket.

As described above, according to the present invention, both maintenance of sealability and reduction of manufacturing cost in the gasket mounting structure in which the gasket is integrally formed is realized with good balance.

### BRIEF DESCRIPTION OF THE DRAWINGS

FIG. 1 a plan view showing a gasket mounting structure which is an embodiment according to the present invention.

FIG. 2 is a plan view showing the gasket mounting structure in FIG. 1 from the opposite side of FIG. 1.

FIG. 3 is a cross-sectional view of the mounting structure in FIG. 1 along XX′ line of FIG. 1.

FIG. 4 is an enlarged view of a cross section of a gasket in the right side part of FIG. 3.

FIG. 5 is a cross-sectional view of the mounting structure in FIG. 1 along YY′ line of FIG. 1.

FIG. 6 is an enlarged view of a cross section of the gasket in the upper side part of FIG. 5.

FIG. 7 is a view showing the state of the gasket in FIG. 4 when the gasket is in contact with the opposing member.

FIG. 8 is a cross-sectional view of a gasket in a gasket mounting structure in which only one lip portion is present.

FIG. 9 is a view showing the gasket in FIG. 8 when the gasket is deformed in contact with an opposing member which is not shown in FIG. 8.

### DETAILED DESCRIPTION

Embodiment according to the present invention will be described below referring to the drawings. It should be understood that the present invention is not limited to the following embodiment, and modifications, improvements, and the like can be made as appropriate based on ordinary knowledge of a person skilled in the art without departing from the spirit of the present invention.

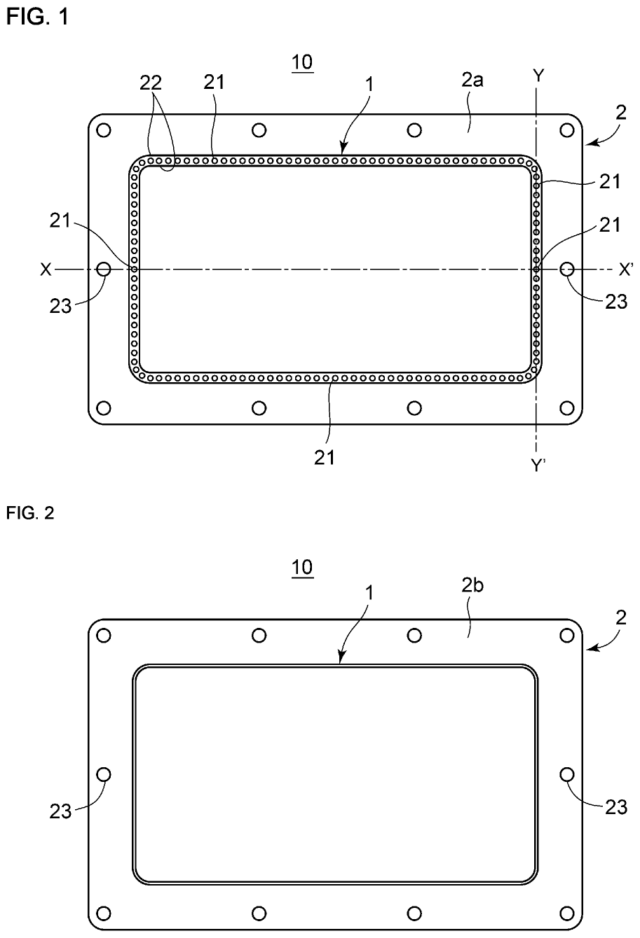

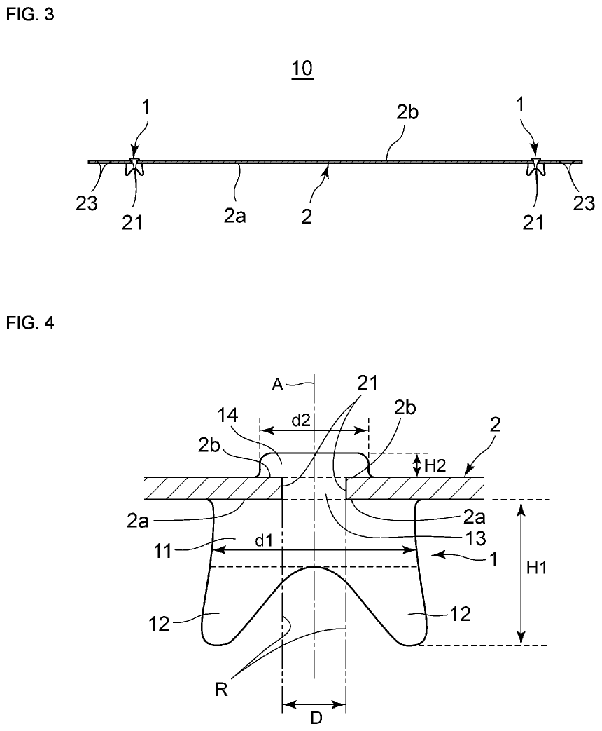

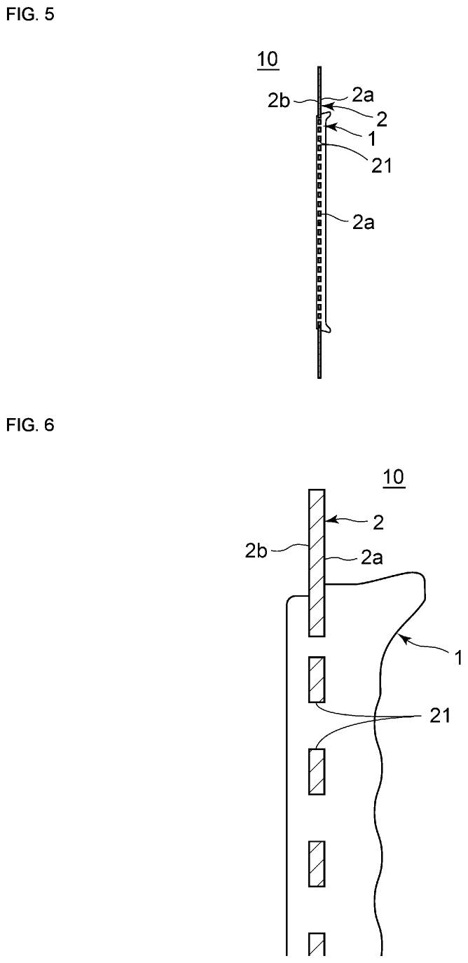

FIG. 1 is a plan view showing a gasket mounting structure 10 which is an embodiment according to the present invention, and FIG. 2 is a plan view showing the gasket mounting structure 10 in FIG. 1 from the opposite side of FIG. 1. In addition, FIG. 3 is a cross-sectional view of the mounting structure 10 in FIG. 1 along XX′ line of FIG. 1, and FIG. 4 is an enlarged view of a cross section of a gasket in the right side part of FIG. 3. Moreover, FIG. 5 is a cross-sectional view of the mounting structure 10 in FIG. 1 along YY′ line of FIG. 1, and FIG. 6 is an enlarged view of a cross section of the gasket in the upper side part of FIG. 5.

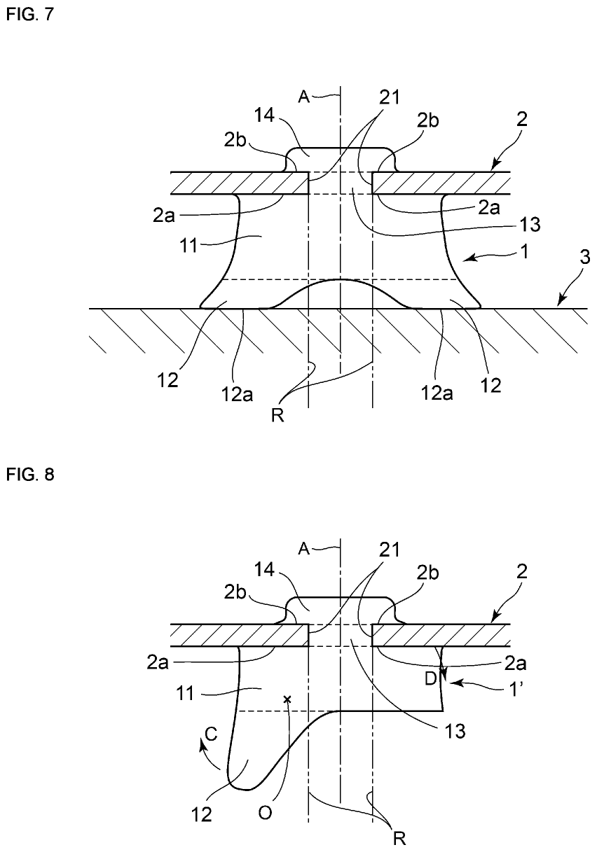

The gasket mounting structure 10 is for mounting, to a gasket mounting member 2 having a plate shape, a gasket 1 that seals a gap between the gasket mounting member 2 and an opposing member (not shown in FIGS. 1 to 6, but see an opposing member 3 in FIG. 7) opposing the gasket mounting member 2.

Here, the gasket 1 is a member that is endlessly formed by an elastic material, and is manufactured, for example, by integrally forming a rubber material in an endless shape on the gasket mounting member 2. A sealing mechanism in which the above-mentioned gasket mounting structure 10 is used is used to seal (i.e., isolate from the outside) an inner space surrounded by the gasket 1.

As shown in FIGS. 1 and 3, the gasket mounting member 2 is provided with one or more through holes 21 penetrating the gasket mounting member 2, in a mounting area 22 thereof which has an endless shape corresponding to a shape of the gasket 1 and on which the gasket 1 is mounted. FIG. 1 shows, as an example of the one or more through holes 21, a lot of small through holes 21 discretely formed along the mounting area 22 (although the through holes 21 are omitted in FIG. 2). However, this is merely an example, and the one or more through holes in the present invention may be a lot of small through holes 21 discretely formed as shown in FIG. 1, or may be several through holes each having an elongated rectangular opening extending along the mounting area 22. Furthermore, the one or more through holes may be a single through hole with an elongate opening extending along the mounting area 22 in a manner close to a shape of a ring (in other words, in a manner of a shape in which a part of a complete ring is missing).

Here, FIG. 1 shows the gasket mounting structure 10 from the side of an opposing surface 2a opposing the aforementioned opposing member (not shown in FIGS. 1 to 6, but see an opposing member 3 in FIG. 7), of both surfaces of the gasket mounting member 2 having a plate shape. On the other hand, FIG. 2 shows the gasket mounting structure 10 from the side of a non-opposing surface 2b on the opposite side of the opposing surface 2a, of the both surfaces of the gasket mounting member 2. In the cross-sectional view of FIG. 3, in the cross-section of the gasket mounting member 2 having a plate shape which has a thickness, a lower edge of the gasket mounting member 2 is shown as the opposing surface 2a, and an upper edge of the gasket mounting member 2 is shown as the non-opposing surface 2b. Similarly, in the cross-sectional view of FIG. 5, in the cross-section of the gasket mounting member 2 of plate shape having a thickness, the right edge of the gasket mounting member 2 is shown as the opposing surface 2a, and the left edge of the gasket mounting member 2 of FIG. 5 is shown as the non-opposing surface 2b. As shown in FIGS. 1 and 2, several fixing holes 23 (10 fixing holes 23 in the example of FIGS. 1 and 2) for fixing the gasket mounting member 2 by a screw mechanism or the like are formed in an peripheral edge portion of the gasket mounting member 2. In the cross-sectional view of FIG. 3, two of the fixing holes 23 are shown.

Hereinafter, the gasket 1 of FIGS. 1 to 6 will be described in detail with reference to FIG. 4.

The gasket 1 is formed integrally with the gasket mounting member 2 in a non-adhesive manner, on the both surfaces (i.e., the opposing surface 2a and the non-opposing surface 2b) of the gasket mounting member 2 along the mounting area 22 and within each of the through holes 21. As a forming method, for example, insert molding in which the gasket 1 is molded in a state in which the gasket mounting member 2 is disposed between the dies can be utilized.

Since the gasket 1 is integrally formed in a non-adhesive manner as described above, an adhesion process for adhering the gasket 1 to the gasket mounting member 2 with an adhesive or the like is unnecessary in the gasket mounting structure 10, and the adhesion process is omitted, whereby the manufacturing cost thereof is reduced.

As shown in FIG. 4, the gasket 1 includes, as constituting portions thereof, the first base portion 11, the second base portion 14, the third base portion 13, and the lip portion 12 when the gasket 1 is considered as being divided into portions thereof, although the gasket 1 is a member which is integrally formed.

The first base portion 11 is a portion having an endless shape, that is disposed on the opposing surface 2a and extends along the mounting area 22 (not shown in FIG. 4, but see FIG. 1) having the endless shape. A width d1 of the first base portion 11 along the opposing surface 2a is wider than a hole size D of each of the through holes 21. Here, the “hole size” refers to the maximum width in a direction (horizontal direction in FIG. 4) orthogonal to both a direction in which the hole extends and a direction in which the mounting area 22 having the endless shape extends. For example, if each of the through holes 21 is a hole having a circular opening, a hole diameter (a diameter of the hole) corresponds to the “hole size”. In addition, when each of the through holes 21 is a hole having an elongated rectangular opening along the direction in which the mounting area 22 having the endless shape extends, the width of the rectangular opening (the width of the shorter side of the rectangle) corresponds to the “hole size”.

The second base portion 14 is a portion having an endless shape, that is disposed on the non-opposing surface 2b and extends along the mounting area 22 (not shown in FIG. 4, but see FIG. 1) having the endless shape. A width d2 of the second base portion 14 along the non-opposing surface 2b is wider than the hole size D of each of the through holes 21 and narrower than the width d1 of the first base portion 11.

The third base portion 13 is a portion that is disposed within each of the through holes 21, and connects the first base portion and the second base portion.

As described above, the first base portion 11 and the second base portion 14 that have the widths which are wider than the hole size D of each of the through holes 21 and that are connected by the third base portion 13 are present on the both surfaces of the gasket mounting member 2, whereby the gasket 1 is firmly fixed on the gasket mounting member 2 even though it is in a non-adhesive manner.

The lip portion 12 is a portion that is connected to the first base portion 11 on the opposite side of the third base portion 13. The lip portion 12 protrudes, in such a manner that a distal end of the lip portion 12 is not included in an extension region R of each of the through holes 21 extending in a penetrating direction thereof, from the first base portion 11 in a direction away from each of the opposing surface 2a and the extension region R. Here, a height H1 from the opposing surface 2a to the most top edge of the distal end is higher than a height H2 of the second base portion 14 in a direction perpendicular to the non-opposing surface 2b.

FIG. 7 is a view showing the state of the gasket 1 in FIG. 4 when the gasket is in contact with the opposing member 3.

The lip portion 12 protrudes in the manner of not being included in the extension region R, whereby a sealing surface 12a of the lip portion 12 contacting the opposing member 3 is apart from immediately below each of the through holes 21 (i.e., the extension region R) as shown in FIG. 7 when the gasket 1 is in contact with the opposing member 3.

Generally, in a type of gasket which is molded with an elastic member and enters into a through hole, thickness of the elastic member is substantially larger at a portion thereof immediately below the through hole than at a portion thereof around the through hole, due to the presence of the elastic member occupying the space of the through hole, whereby shrinkage (sink) of the gasket after the gasket is molded is larger immediately below the through hole than around the through hole. Therefore, the gasket tends to be slightly more recessed immediately below the through hole than around the through hole, and when a plurality of the through holes are arranged, a surface of the gasket facing the opposing member 3 (see FIG. 7) is likely to have corrugated irregularities as shown in the right edge of the gasket 1 in FIG. 6. This leads to a difference in compressibility of the gasket between a portion thereof immediately below the through hole and another portion thereof around the through hole, so there is a concern that the difference in compressibility may affect the scalability of the gasket.

In the present embodiment, however, the sealing surface 12a of the lip portion 12 is apart from immediately below each of the through holes 21, and therefore, even if there is a difference in compressibility of the gasket 1 between a portion thereof immediately below the through hole and another portion thereof around the through hole, the difference is prevented from affecting scalability of the gasket.

As described above, according to the present embodiment, both maintenance of scalability and reduction of manufacturing cost in the gasket mounting structure in which the gasket is integrally formed is realized with good balance.

Here, as shown in FIG. 4, it is preferable that the lip portion 12 protrudes in an oblique direction to the extension region R of each of the through holes 21 which is the direction away from the extension region R, in a plane including a center line A of the each of the through holes 21 and being perpendicular to a direction in which the mounting area 22 extends.

In general, the gasket 1 endlessly formed as shown in FIG. 2 may have large variation in a value of a width thereof due to manufacturing errors or the like. In such cases, if the lip portion 12 extends perpendicularly from the opposing surface 2a of the gasket mounting member 2, the lip portion 12 is easily bent in any direction (for example, in any direction of the left and right directions of FIG. 4 in the cross-sectional view as shown in FIG. 4) when the lip portion 12 is pressed against the opposing member 3 (see FIG. 7). In this case, it is difficult to accurately estimate the bending direction, and a stable sealability may not be exhibited. In contrast, in the embodiment as shown in FIG. 4 in which the lip portion 12 extends in an oblique direction to the extension region R which is the direction away from the extension region R, it is easy to estimate the bending (deformation) direction of the lip portion 12, and a stable sealability can be exhibited. In addition, when compression in a direction perpendicular to the opposing surface 2a (see FIG. 7) is applied to the lip portion 12, the lip portion 12 is deformed in such manner that the lip portion 12 is bent, whereby a reaction force of the lip portion 12 can be suppressed to a low level.

Here, as shown in FIG. 4, it is preferable that the gasket 1 further includes a plurality of the lip portions 12 (for example, two lip portions 12 in FIG. 4) which are disposed on opposite sides with the center line A therebetween and protrude in the oblique directions which are different from each other.

If there exists only one lip portions 12 on one side, of the two lip portions 12 in FIGS. 4 and 7, the first base portion 11 on the side having no lip portion with respect to the center line A of each of the through holes 21 is likely to be separated from the opposing surface 2a due to its non-adhesive manner to the opposing surface 2a when the lip portion 12 and the opposing member 3 are pressed against each other. This point will be described below.

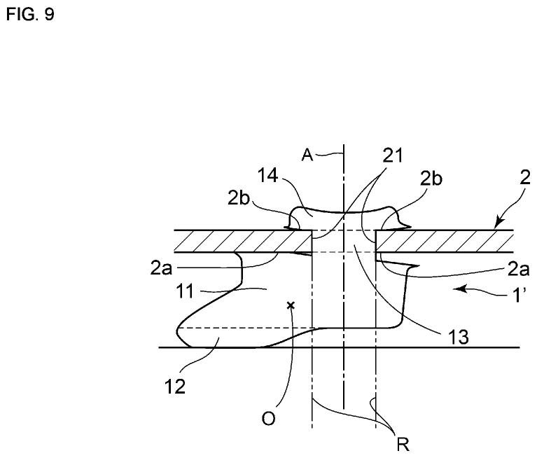

FIG. 8 is a cross-sectional view of the gasket 1′ in the gasket mounting structure in which only one lip portion 12 is present, and FIG. 9 is a view showing the gasket 1′ in FIG. 8 when the gasket 1′ is deformed in contact with an opposing member which is not shown in FIG. 8.

In FIG. 8, the same components as those in FIGS. 1 to 7 are denoted by the same reference numerals, and redundant description of the components will be omitted. The gasket 1′ in FIG. 8 differs from the gasket 1 in FIG. 4 in that the gasket 1′ in FIG. 8 has a shape having only one lip 12, and except this point, the gasket mounting structure having the gasket having the gasket 1′ and the gasket mounting member 2 in FIG. 8 is the same as the gasket mounting structure 10 described in FIGS. 1 to 7.

When the gasket 1′ in FIG. 8 abuts against the opposing member which is not shown in FIG. 8, the lip portion 12 is deformed in such a manner that the lip portion 12 rotates in the direction of an arrow C in FIG. 8 around the point O in FIG. 8 due to the pressure contact force received from the opposing member (refer to the lip portion 12 in FIG. 9 that is deformed). Accordingly, a contacting surface of the first base portion 11 on the opposite side of the lip portion 12 with respect to the center line A receives a force to rotate the contacting surface in a direction of an arrow D in FIG. 8 around the point O in FIG. 8. At this time, the contacting surface of the first base portion 11 is likely to be separated from the opposing surface 2a due to its non-adhesive manner to the opposing surface 2a. If the separation is extremely large, the scalability may be deteriorated due to a gap caused by the separation.

On the other hand, when there is another lip portion 12 in addition to the one lip portion 12 in such a manner that they are disposed on opposite sides with the center line A therebetween and protrude in the oblique directions which are different from each other (see FIG. 4), another force that induces rotation in a direction opposite to the rotation direction in FIG. 8 acts on the gasket 1. Therefore, as compared with the case in which there exits only the one lip portion 12, the first base portion 11 is less likely to be separated.

When there exists a plurality of the lip portions 12 which protrude in the oblique directions which are different from each other, as described above, it is particularly preferable that the plurality of the lip portions 12 extend at positions symmetrical to the center line A in the oblique directions symmetrical to the center line A.

According to this particularly preferable case, the forces which cause the non-adhesive first base portion 11 to be separated from the opposing surface 2a are likely to be offset on both sides of the extension area R (that is, on both sides of the center line A of each of the through holes 21), and the deterioration of the scalability due to the separation of the first base portion 11 is further suppressed. When there are two lip portions 12 in this particularly preferable case, it is preferable from the viewpoint of stable scalability that a distance between the most top edges of the distal ends of the two lip portions 12 is longer than the width d2 of the second base portion.

In the embodiment of FIGS. 1 to 7 described above, there exist a plurality of lip portions (for example, two lip portions in FIG. 4). However, in a situation where the pressure contact force between the lip portion 12 and the opposing member 3 is not so large that deterioration in sealability due to the separation of the first base portion 11 is unlikely to occur, the present invention may employ an embodiment in which there exits only one lip portion 12 on one side as shown in FIG. 8. Such an embodiment is the same as the gasket mounting structure 10 described with reference to FIGS. 1 to 7, except that there exists only the one lip 12 on the one side, and a satisfactory sealability is ensured in the same way. Further, since there is only the one lip portion 12 on the one side with respect to the center line A, molding of the lip portion 12 is somewhat easier than molding a plurality of lip portions so as to be symmetrical with respect to the center line A and thus it is also suitable for reducing the manufacturing cost. Therefore, under the condition that deterioration in sealability due to the separation of the first base portion 11 is unlikely to occur, also in such an embodiment as that of FIG. 8, both maintenance of sealability and reduction of manufacturing cost is realized with good balance. Further redundant explanation of this embodiment will be omitted.

The above is an explanation of embodiment according to the present invention.

Although the above description of FIGS. 1 to 7 have described an embodiment having the two lip portions 12 symmetrical with respect to the center line A of each through hole 21, embodiments having four or more even number of the lip portions 12 symmetrical with respect to the center line A of each of the through holes 21 may be employed in the present invention.

### INDUSTRIAL APPLICABILITY

The present invention is useful in a gasket mounting structure in which a gasket is integrally formed, for realizing both maintenance of sealability and reduction of manufacturing cost with good balance.

1. A gasket mounting structure for mounting, to a gasket mounting member having a plate shape, a gasket endlessly formed by an elastic material that seals a gap between the gasket mounting member and an opposing member opposing the gasket mounting member, wherein
the gasket mounting member is provided with one or more through holes penetrating the gasket mounting member, in a mounting area thereof which has an endless shape corresponding to a shape of the gasket and on which the gasket is mounted, and
the gasket is formed integrally with the gasket mounting member in a non-adhesive manner, on both surfaces of the gasket mounting member along the mounting area and within the one or more through holes, and includes:
a first base portion having an endless shape, that is disposed on an opposing surface opposing the opposing member, of the both surfaces of the gasket mounting member, that extends along the mounting area having the endless shape, and that has a width along the opposing surface which is wider than a hole size of each of the one or more through holes,
a second base portion having an endless shape, that is disposed on a non-opposing surface on the opposite side of the opposing surface, of the both surfaces of the gasket mounting member, that extends along the mounting area having the endless shape, and that has a width along the non-opposing surface which is wider than the hole size of each of the one or more through holes and narrower than the width of the first base portion,
a third base portion that is disposed within each of the one or more through holes and connects the first base portion and the second base portion, and
a lip portion that is connected to the first base portion on the opposite side of the third base portion and protrudes, in such a manner that a distal end of the lip portion is not included in an extension region of each of the one or more through holes extending in a penetrating direction thereof, from the first base portion in a direction away from each of the opposing surface and the extension region.

2. The gasket mounting structure according to claim 1, wherein the lip portion protrudes in an oblique direction to the extension region of each of the one or more through holes which is the direction away from the extension region, in a plane including a center line of the each of the one or more through holes and being perpendicular to a direction in which the mounting area extends.

3. The gasket mounting structure according to claim 2, wherein the gasket includes a plurality of the lip portions which are disposed on opposite sides with the center line therebetween and protrude in the oblique directions which are different from each other.

4. The gasket mounting structure according to claim 3, wherein the plurality of the lip portions extend at positions symmetrical to the center line in the oblique directions symmetrical to the center line.
